(19) United States
(12) Patent Application Publication
(10) Pub. No.: US 2024/0328518 A1
(43) Pub. Date: Oct. 3, 2024

(54) Gate Valve with Novel Seal and Sealing Arrangement

(71) Applicant: Edge Mechanical Design Inc., Red Deer (CA)

(72) Inventor: Daine Strankman, Red Deer (CA)

(21) Appl. No.: 18/618,960

(22) Filed: Mar. 27, 2024

Related U.S. Application Data
(60) Provisional application No. 63/454,952, filed on Mar. 27, 2023.

(51) Int. Cl. F16K 3/02

(52) U.S. Cl. CPC F16K 3/0227

(57) ABSTRACT

In one aspect there is provided a gate valve having a first end and a second end, a gate having a gate opening. The gate is positionable within the valve between a closed configuration, a transition configuration and an open configuration. The gate valve further comprises a gate stem, at least one pair of seals, with one seal positioned on either side of the gate. Each of the seals comprises a first profile and a second profile. The first profile seals the gate valve and blocks fluid from passing between the first end and the second end when the gate valve is in the closed configuration. The second profile seals the gate opening relative to the gate stem. In another embodiment, the gate valve comprises two pairs of seals and the first and second profiles are each provided on separate seals.

### CROSS REFERENCE TO RELATED APPLICATION

This application is a non-provisional application which claims priority to, and benefit of, U.S. Provisional Patent Application Ser. No. 63/454,952 filed Mar. 27, 2023 and entitled, “Gate Valve with Novel Seal and Sealing Arrangement”, the entirety of which is incorporated herein by reference.

### FIELD OF THE INVENTION

This invention relates in general to gate valves, and in particular to a gate valve that that has a novel seal and sealing arrangement to prevent suspended solids from passing into a gate valve's gate chamber and collect around the stem of a gate.

### BACKGROUND OF THE INVENTION

The background information discussed below is presented to better illustrate the novelty and usefulness of the present invention. This background information is not admitted prior art.

Referring to FIG. 1, a conventional, prior-art gate valve has a body with a cavity or gate chamber that is intersected by a flow passage. A planar member, the gate, moves within the gate chamber between open and closed configurations or positions. When the gate is positioned between the open and closed configurations, it can be said to be in a transition position or configuration. The gate has a hole or gate opening through it that aligns with the flow passage while in the open configuration. The gate can be translated within the gate valve so that the gate opening is in alignment with the flow passageway, i.e. moved to the open configuration in which the gate valve allows fluid to flow through it from one side to the other. However, when the gate is translated to a configuration so that the gate opening within the gate is sufficiently out of alignment and unregistered with the flow passageway, i.e. to the closed configuration, the flow through the gate is substantially blocked such that fluid does not pass from one side of the gate valve to the other.

A circular flow passage seal, gate seal or seat ring is typically provided at each intersection of the flow passage with gate chamber. Gate seals/seat rings are typically metal rings having seal surfaces on their inner faces which are biased against flat faces of the gate when in the closed configuration and thereby creating a sealed arrangement wherein flow from one end of the flow passage to the other end is prevented. Typically, the flat face of the gate that seals will be a downstream side, thus the sealing engagement depends on the direction of flow through flow passage.

One common way of translating the gate within the valve is by manually rotating a hand-wheel. The hand-wheel is typically attached to a threaded area within the gate valve system so that when the wheel turns, it moves a stem attached to the gate and causes the gate to translate linearly within the gate chamber. The stem is typically housed in the gate valve within a stem cavity or stem chamber, as well as within part of the gate chamber (depending on the position of the gate within the valve), as shown in FIG. 1. Another way of translating the gate within the valve is through the use of a hydraulic actuation device acting on the gate via the stem.

Typically, a stem seal is provided in the stem chamber to sealable engage the stem, to seal pressure within the gate chamber and prevent fluids from the flow passage from escaping out the gate valve via the stem chamber. However, fluids from the flow passage will normally still circulate or move through the gate chamber, bypassing the gate seals and collecting up above the gate and around the stem, especially when the gate is partially positioned between the open and closed configurations (see FIG. 1).

Often gate valves carry fluids that contain suspended solids or debris. This is especially so when gate valves are utilized during oil field hydraulic fracturing operations (also known as hydrofracking, fracking, fracing, or hydrofracturing) where fluids passing through a gate valve carry sand, proppants or other solids. These solid particles can clog the gate chamber where they can concentrate, pack and in some cases solidify; especially so above the gate and around the stem. As such, gate valves must be periodically cleaned or flushed out; e.g. with grease forced in the top of the gate chamber and then out into the flow passage.

Moreover, during such flushing procedure it is better if the flow passage is oriented substantially horizontal, and the stem chamber is positioned above the flow passage, to allow the sand, proppants and other solids and debris to be easily flushed downward (and out the flow passage) and prevent them from remaining stuck within the gate chamber and/or around the stem. However, often times it is desirable to orient the flow passage at an angle that is not substantially horizontal (e.g. substantially vertical). In such cases, it is much more difficult, if not impossible, to flush out the sand, proppants or other solids from the stem chamber.

Therefore, what is needed is a gate valve that does not suffer from these disadvantages.

### SUMMARY OF THE INVENTION

In an embodiment of the invention, there is provided a gate valve having a first end and a second end, a gate having a gate opening. The gate is positionable within the valve between a closed configuration, a transition configuration and an open configuration. The gate valve further comprise a gate stem, at least one pair of seals, with one seal positioned on either side of the gate. Each of the seals comprises a first profile and a second profile. The first profile seals the gate valve and blocks fluid from passing between the first end and the second end when the gate valve is in the closed configuration. The second profile seals the gate opening relative to the gate stem.

In another embodiment, the gate valve comprises two pairs of seals and the first and second profiles are each provided on separate seals. In a preferred embodiment, the gate valve further comprises a valve main body and a valve end cap.

### BRIEF DESCRIPTION OF THE DRAWINGS

Referring to the drawings, several aspects of the present invention are illustrated by way of example, and not by way of limitation, in detail in the figures, wherein:

FIG. 1 is a sectional view of a PRIOR ART gate valve shown in a transition position and illustrating solids buildup in the gate chamber;

FIG. 2A is a perspective view of a gate valve according to an embodiment of the invention;

FIG. 2B is another perspective view of the gate valve of the embodiment of FIG. 2A;

FIGS. 3A-3C are sectioned perspective views of the gate valve of the embodiment of FIG. 2A, in a closed, transition, and open configuration respectively;

FIGS. 4A-4C are sectioned views of the gate valve of the embodiment of FIG. 2A, in a closed, transition, and open configuration respectively;

FIGS. 5A-5C are sectioned perspective views of certain components of the gate valve of the embodiment of FIG. 2A, in a closed, transition, and open configuration respectively;

FIGS. 5D-5E are perspective views of certain components of the gate valve of the embodiment of FIG. 2A, in a transition, configuration;

FIGS. 6A-6B are perspective views of certain components of the gate valve of the embodiment of FIG. 2A;

FIG. 6C is a sectioned perspective view of certain components of the gate valve of the embodiment of FIG. 2A;

FIGS. 7A-7C are perspective views of a preferred embodiment of a gate valve body;

FIGS. 8A-8C are perspective views of a preferred embodiment of a gate valve cap;

FIG. 9A is an exploded perspective view of the gate valve body of the embodiment of FIG. 7A with a preferred embodiment of a flow passage seal;

FIG. 9B is an exploded perspective view of the gate valve cap of the embodiment of FIG. 8A with the embodiment of a flow passage seal of FIG. 9A;

FIG. 9C is an exploded, sectioned perspective view of the gate valve body of the embodiment of FIG. 7A, the gate valve cap of the embodiment of FIG. 8A, and a pair of the flow passage seals of the embodiment of FIG. 9A;

FIGS. 10A-10B are exploded perspective views of certain components of the gate valve of the embodiment of FIG. 2A;

FIGS. 11A-11B are front and rear perspective views of the flow passage or gate seals of the embodiment of FIG. 9A;

FIG. 11C is a front perspective view of a portion of the flow passage seal of the embodiment of FIG. 9A, illustrating only the stadium profile portion;

FIG. 12A is a perspective views of certain components of the gate valve of the embodiment of FIG. 2A, illustrating placement of shims against the gate valve body;

FIG. 12B is a sectioned view of the gate valve of the embodiment of FIG. 2A, illustrating placement of multiple layers of shims between the gate valve body and gate valve cap;

FIG. 12C is an enlargement of the area B in FIG. 12B;

FIG. 12D is a sectioned view of the gate valve of the embodiment of FIG. 2A, illustrating placement of a single layer of shims between the gate valve body and gate valve cap;

FIG. 12E is an enlargement of the area D in FIG. 12D;

FIG. 13A is a perspective view of certain components of a gate valve according to another embodiment of the invention;

FIG. 13B is a sectioned perspective view of certain components of the gate valve of the embodiment of FIG. 13A;

FIG. 13C is a perspective view of certain components of the gate valve of the embodiment of FIG. 13A;

FIG. 13D is a perspective view of certain components of the gate valve of the embodiment of FIG. 13A;

FIGS. 13E-13F are front and rear perspective views of a flow passage or gate seal of the embodiment of FIG. 13A;

FIG. 14 is a perspective view of certain components of a gate valve according to yet another embodiment of the invention;

FIG. 15A is a sectioned view of yet another embodiment of the gate valve of the present invention, showing the stem nut centered within the nut cavity;

FIG. 15B is an enlarged view of the area B in FIG. 15A;

FIG. 15C is a sectioned view of the embodiment of FIG. 15A, now showing the stem nut offset to one end within the nut cavity;

FIG. 15D is an enlarged view of the area B′ in FIG. 15C;

FIG. 15E is a sectioned view of the embodiment of FIG. 15A, now showing the stem nut offset to another end within the nut cavity; and

FIG. 15F is an enlarged view of the area B′ in FIG. 15C.

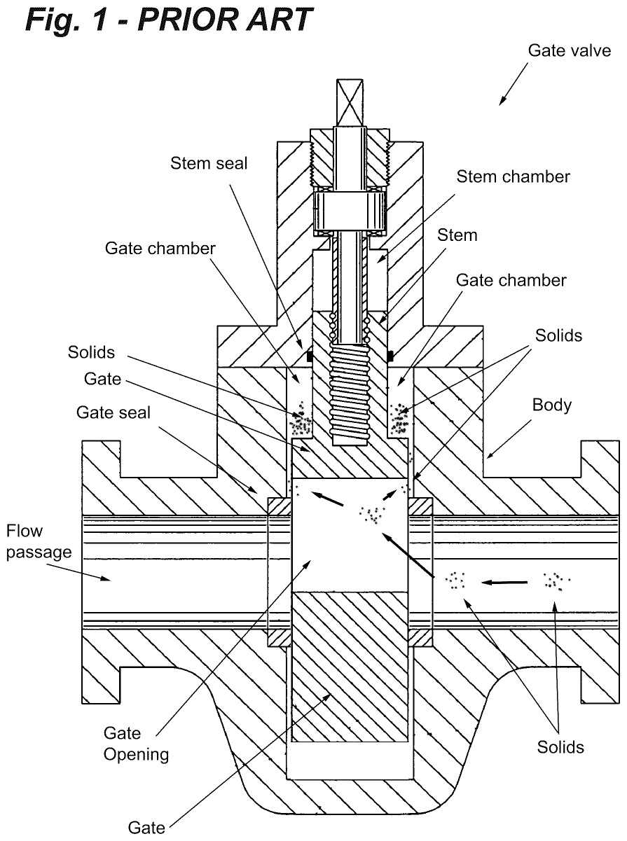

### DETAILED DESCRIPTION OF THE PREFERRED EMBODIMENTS

The following description is of preferred embodiments by way of example only and without limitation to the combination of features necessary for carrying the invention into effect. Reference is to be had to the Figures in which identical reference numbers identify similar components. The drawing figures are not necessarily to scale and certain features are shown in schematic or diagrammatic form in the interest of clarity and conciseness.

Additionally, to assist in the description of the invention, words such as top, bottom, upper, lower, above, below, front, rear, right and left are used to describe the accompanying figures. It will be appreciated, however, that the present invention can be located and positioned in a variety of desired positions and angles, and that the various components can be arranged in other suitable configurations. The terms “comprising,” “comprises,” “including,” “includes,” “having,” “haves,” and their grammatical equivalents are used herein to mean that other components, elements or steps are optionally present.

Reference will now be made in detail to an implementation consistent with the present invention as illustrated in the accompanying figures. For the purpose of clarification, embodiments described herein reference the term “fluid,” which refers to a gas, liquid, as well as liquid solution with solid aggregates, as well as any material that can reasonably be expected to flow.

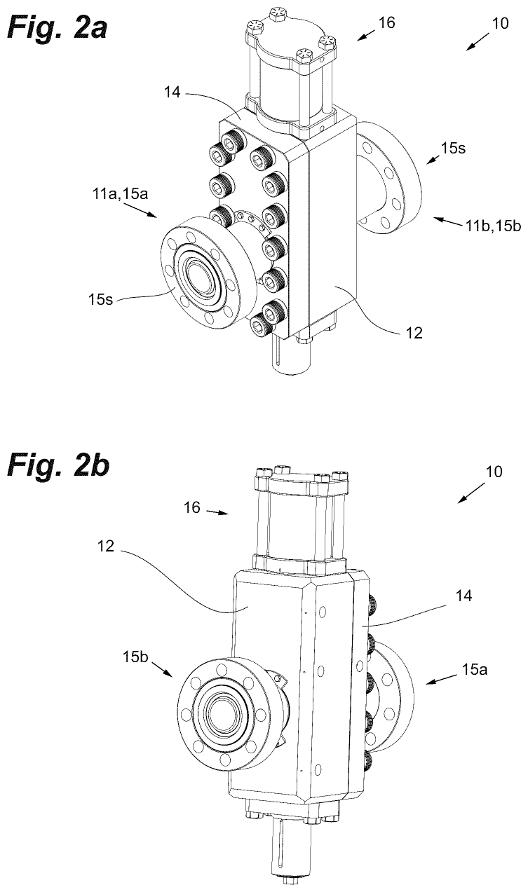

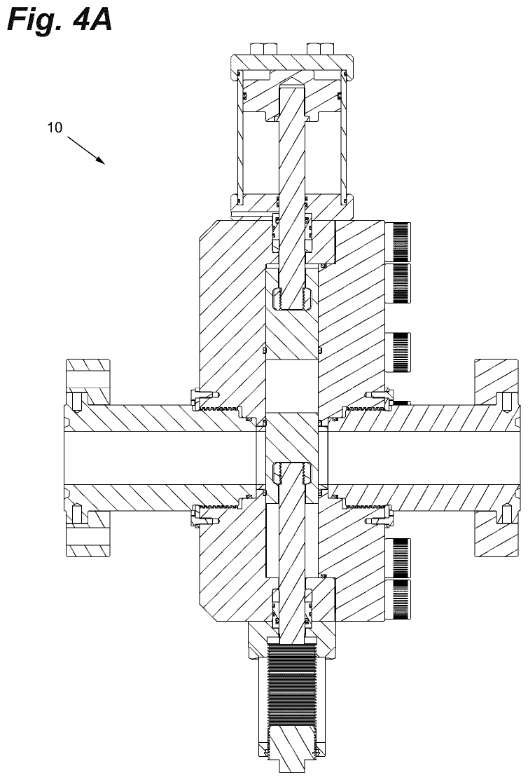

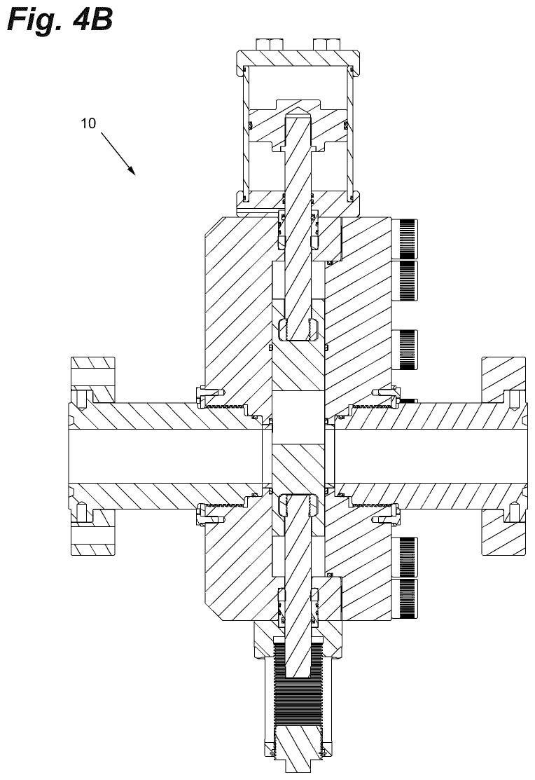

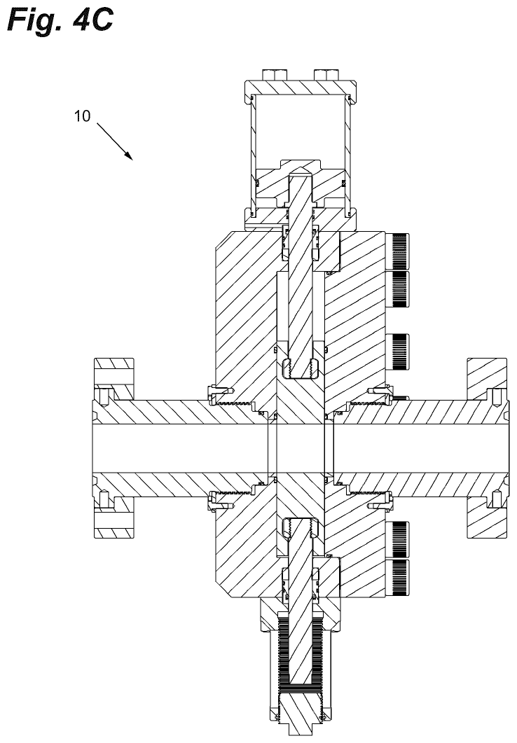

Referring to FIGS. 2A-4C by way of non-limiting example, and consistent with embodiments of the invention, a gate valve 10 is shown. The gate valve 10 includes a valve main body 12, a valve end cap 14, a pair of flanges 15a, 15b at opposing first and second ends 11a, 11b of the valve gate valve 10 (one flange projecting radially from each of valve main body 12 and valve cap 14 as illustrated). Flanges 15a, 15b are designed to accommodate a flange seal (not shown), such as, but not limited to, a metal gasket, on the flange surfaces 15s to enable the gate valve 10 to connect to other components with flanges. While this embodiment shows a flange type connection, other ways to provide connections are known within the art and can be designed as appropriate for the gate valve 10 and related equipment.

The valve 10 also has a top valve face 10t and a bottom valve face 10b to removable attach additional components in a conventional manner, as desired, to the gate valve 10. These additional components may comprise a conventional hydraulic actuation mechanism 16 and a conventional balance rod 17r receivable within a conventional balance rod cap 17c and provided with a manual (threaded) backup 17b. In other embodiments (not shown), the hydraulic actuation mechanism 16 may be replaced with a conventional mechanical actuation mechanism. One of skill in the art will recognize that various commercially available actuation and other mechanisms can be adapted for use with the top valve face 10t and the bottom valve face 10b of the gate valve 10.

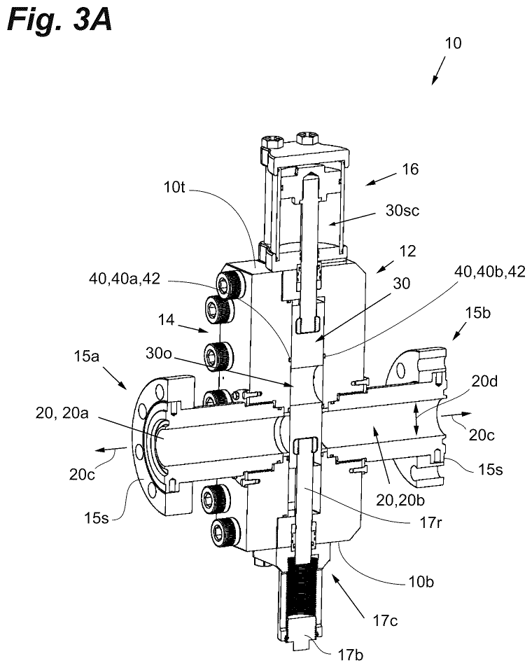

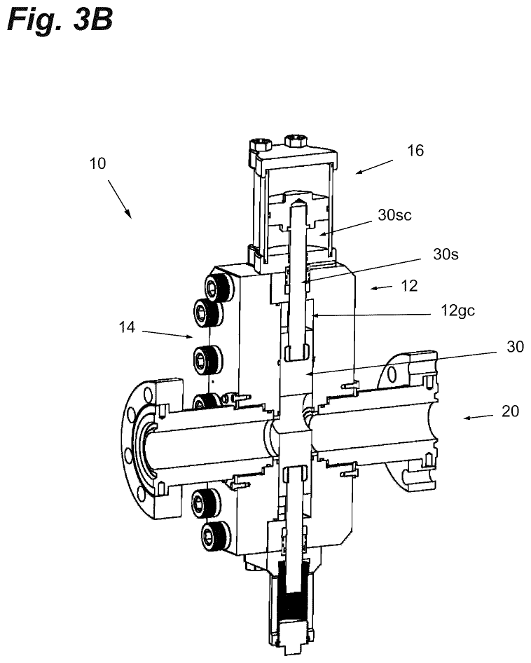

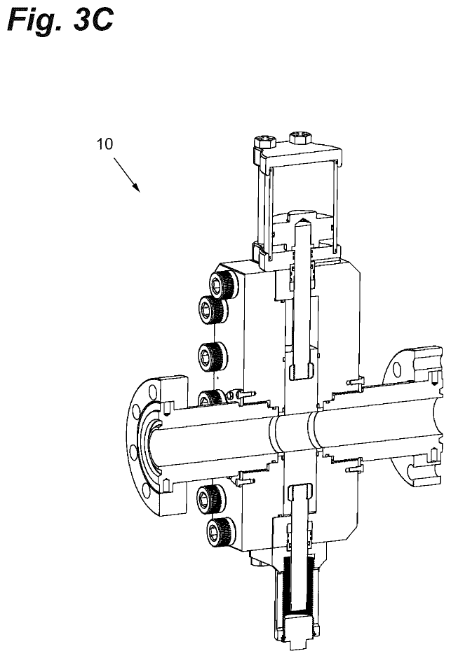

The valve 10 contains a bore or flow passage 20 preferably having a predetermined body bore diameter 20d through which fluid can travel when the gate valve 10 is in an open configuration such that there is not substantial restriction to the flow of fluid between first flange 15a and second flange 15b. The flow passage 20 is preferably symmetric about a bore center-line 20c that passes through the valve 10 and through flange 15a and flange 15b; e.g. through flange 15a at a first flow passage end 20a and through flange 15b at a second flow passage end 20b (see FIG. 3A).

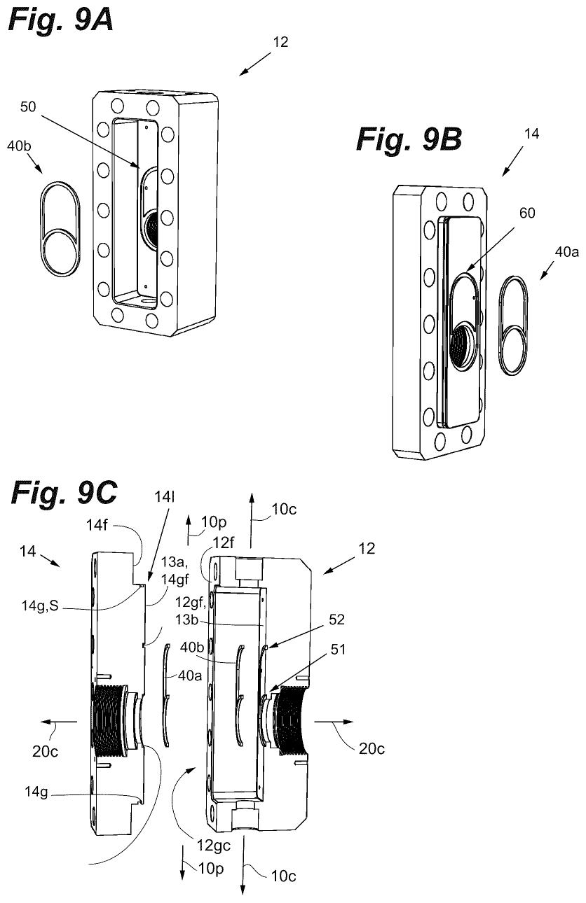

The gate valve 10 also contains a gate cavity or gate chamber 12gc about a gate cavity center-line 10c; see FIGS. 3B and 9C. Preferably, the gate cavity center-line 10c passes through the center of the gate 10 and through the top face 10t and bottom face 10b. More preferably, the gate cavity 12gc is a symmetric about the gate cavity center-line 10c and is an elongate, rectangular cuboid cavity disposed perpendicular to the flow passage 20 thereby permitting a gate 30 to travel or position within the valve 10 between a closed, transition, and open configuration; see FIG. 9C. In this preferred embodiment, gate cavity 12gc is exclusively within the valve main body 12, but in other embodiments (not shown), the gate cavity 12gc may be within both valve main body 12 and valve end cap 14.

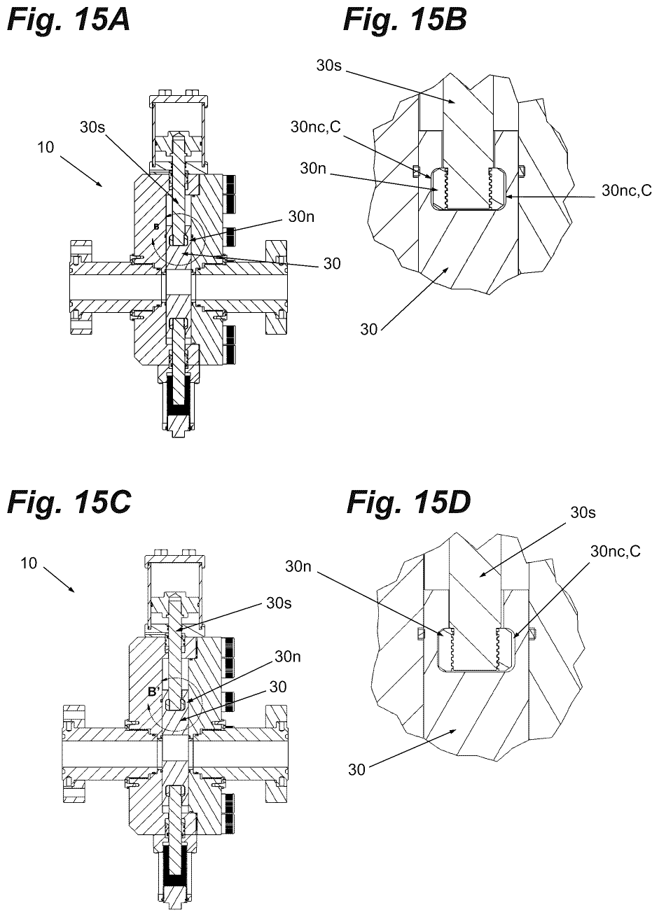

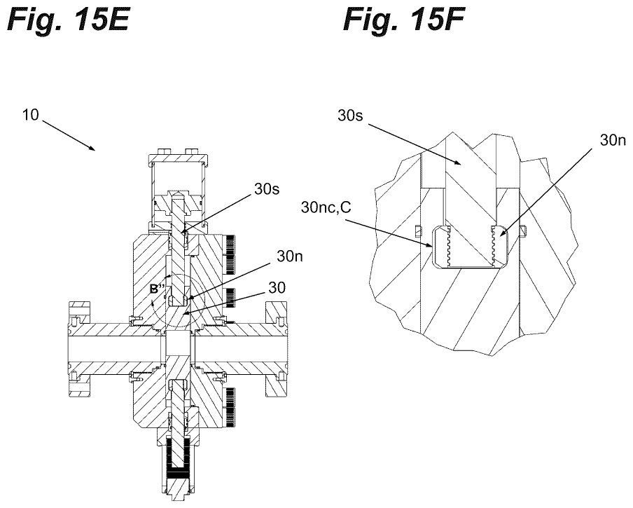

In a preferred embodiment, illustrated in FIGS. 15A-15F, the hydraulic actuation mechanism 16 is connected to the gate 30 in a conventional manner via a gate stem 30s that is preferably threaded into a stem nut 30n captured in a nut cavity 30nc at one end of the gate 30 (see FIGS. 15A-15F). More preferably, nut cavity 30nc is of such dimensions (i.e. somewhat larger than stem nut 30n) to provide some additional clearance about the stem nut 30n; as illustrated in FIG. 15B (stem nut 30n centered within nut cavity 30nc), 15D (stem nut 30n is offset to one end of the valve 10), and 15F (stem nut 30n is offset to the other end of the valve 10). In the preferred embodiment, the additional clearance C is 0.04″ each direction. Advantageously, a gate 30 of slightly different thicknesses can now be accommodated within the valve 10 without having to adjust the positioning of the gate stem 30s relative to the gate cavity center-line 10c. More advantageously, a gate 30 used within the valve 10 may now be coated with a thicker coating (e.g. a tungsten coating) than previously possible in prior art gate valves (e.g. preferably a coating of 30/1000's of an inch versus a conventional coating of 4/1000's of an inch) and, when such gate 30 is subsequently shaved or machined (to remove grooves and imperfections that may have accumulated on the faces of the gate 30), the refurbished gate 30 can still be used within the valve 10, even though it is thinner than before and would otherwise be offset within the gate chamber 12gc, were it not for the clearance C.

Valve end cap 14 further comprises a first mating face 14f preferably oriented along a plane 10p that is substantially parallel to the gate cavity center-line 10c and perpendicular to the bore center-line 20c; see FIG. 9C. Similarly, valve main body 12 further comprises a second mating face 12f preferably oriented also along a plane 10p that is substantially parallel to the gate cavity center-line 10c and perpendicular to the bore center-line 20c; see FIG. 9C.

First and second mating faces 12f, 14f of the valve main body 12 and valve end cap 14 are of such dimensions to enable valve main body 12 and valve end cap 14 to removably, sealably mate or assemble together to form the gate cavity 12gc, to house the gate 30 so that the gate 30 can travel therewithin between the closed, transition, and open configurations, and to maintain a sufficient pressure seal and pressure rating within the gate cavity 12gc to keep any fluids that may be within the gate valve 10 contained in a desired manner, e.g. depending on operational pressure requirements. Advantageously, by having valve main body 12 and valve end cap 14 removably, sealably mate or assemble together to form the gate cavity 12gc, the gate cavity 12 gc can be easily machined or milled out from valve main body 12 during manufacturing.

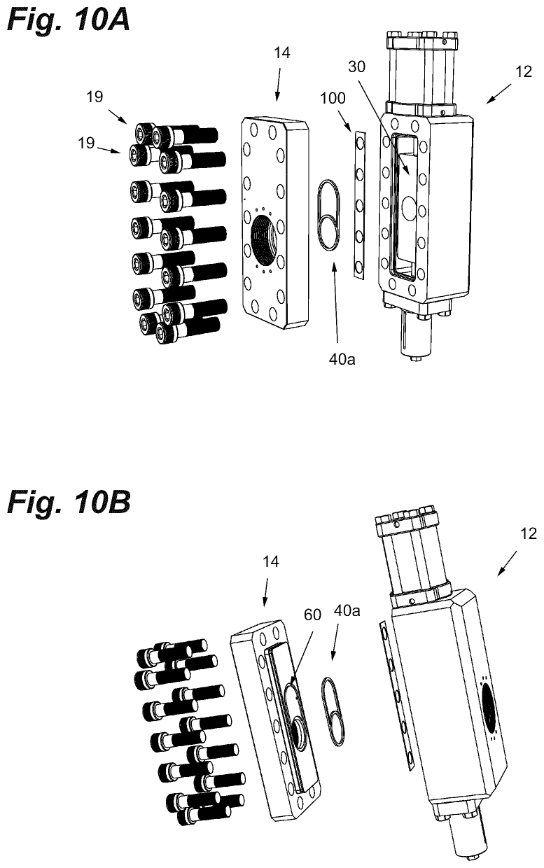

As a non-limiting example, the valve end cap 14 is attached to the main valve body 12 by way of a fastening device such as, but not limited to cap bolts 19; see FIGS. 10A-10B. In the present embodiment, the cap bolts 19 threadably engage in the second mating face 12f via the valve end cap 14. Other fasteners such as, but not limited to, bolts traversing thru-holes in both the valve end cap 14 and the main valve body 12 and secured with a nut, can be used as understood by one of skill in the art. In another embodiment (not show) a seal such as a metal gasket may be provided between the first and second mating faces 12f, 14f to restrict fluid leakage from the gate valve 100.

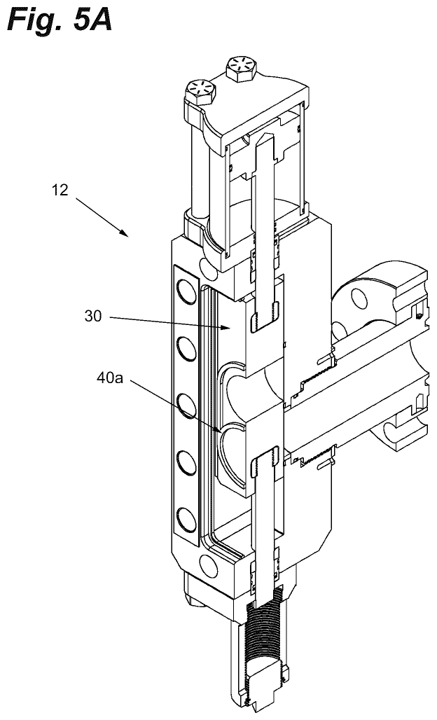

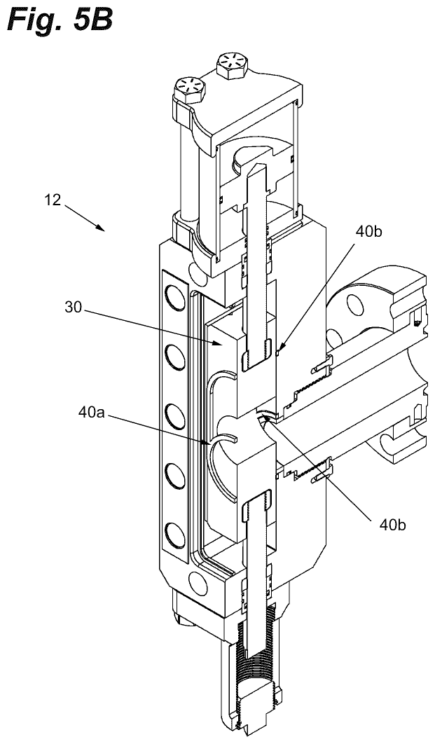

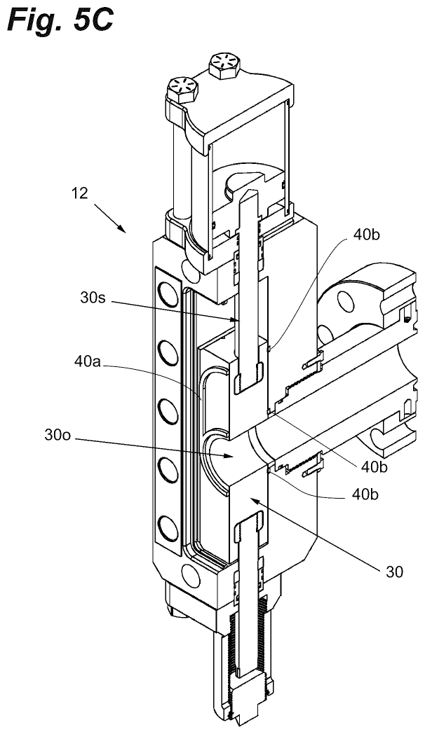

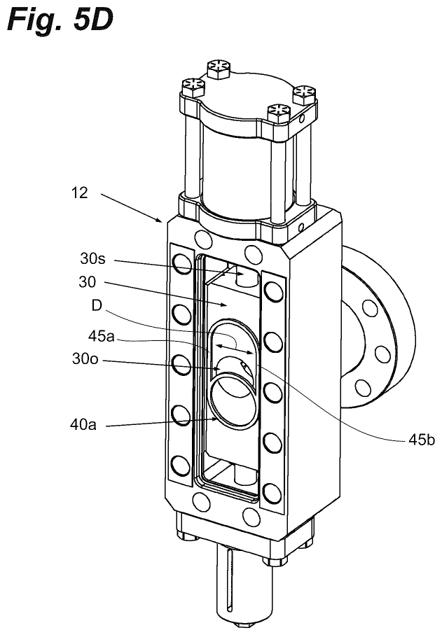

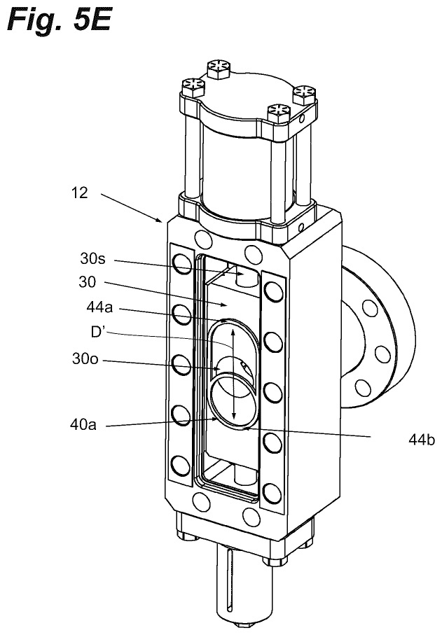

A preferred embodiment of the gate valve 10 preferably further comprises a pair of seats, gate seals or flow passage seals 40, which may be referred to as a first seal 40a and a second seal 40b positioned on either side of the gate 30 (see FIGS. 5A, 5B, 9A, 9B, 9C, 11A and 11B). The first and second seals 40a, 40b of this embodiment each feature a shape or seal profile 40p that is a first profile 41 combined or overlapped with a second profile 42. The first profile 41 is a circular profile (when viewed from the front or rear) comprised only of two semicircular members, namely an inner semicircular member 43a and an outer semicircular member 43b.

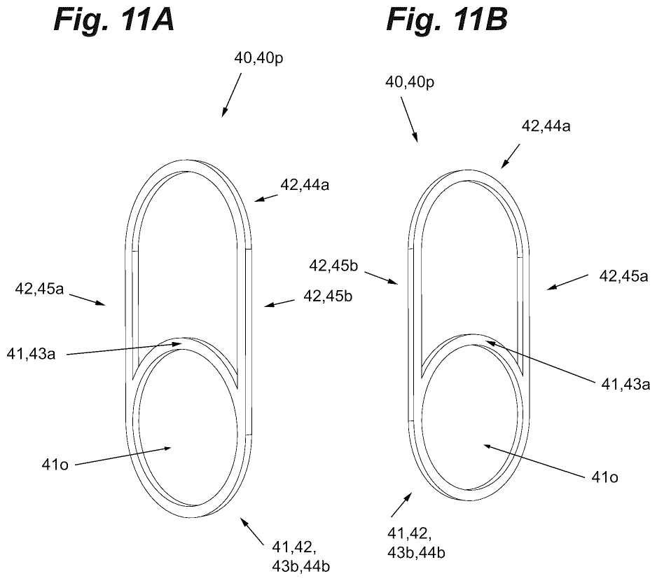

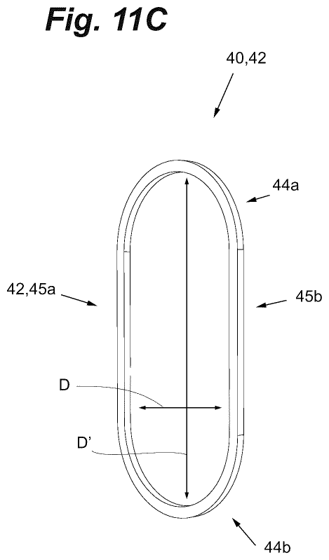

The second profile 42 is a stadium profile (when viewed from the front or rear; see FIG. 11C). The second, stadium profile 42 of the seals 40 comprises a geometric shape constructed of two semicircular members, namely a first semicircular member 44a and a second semicircular member 44b positioned at opposite ends with a pair of straight legs 45a, 45b therebetween. The two profiles 41, 42 combine to comprise the seal profile 40p by virtue of the fact that the outermost semicircular member 43b is the same member as the second semicircular member 44b; see FIGS. 11A-11B.

Preferably, the seals 40 are of a material of sufficient rigidity so that, during actuation of the gate valve 10, no portion of the seal (e.g. inner semicircular member 43a) is pushed or deformed into gate bore or gate opening 300 when under pressure. Materials such as Teflon™, alloy steel, tungsten carbide coated steel, Nylatron™ polymer, Derlin™ polymer, Polytetrafluoroethylene (PFTE) filed Derlin™ polymer, virgin PTFE, carbon filed PTFE, and glass filled PTFE may all be used and their choice for a particular application and pressure rating will be understood by one of skill in the art.

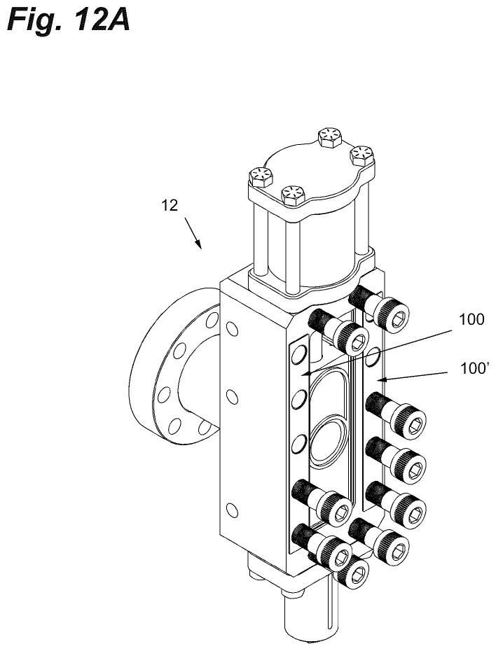

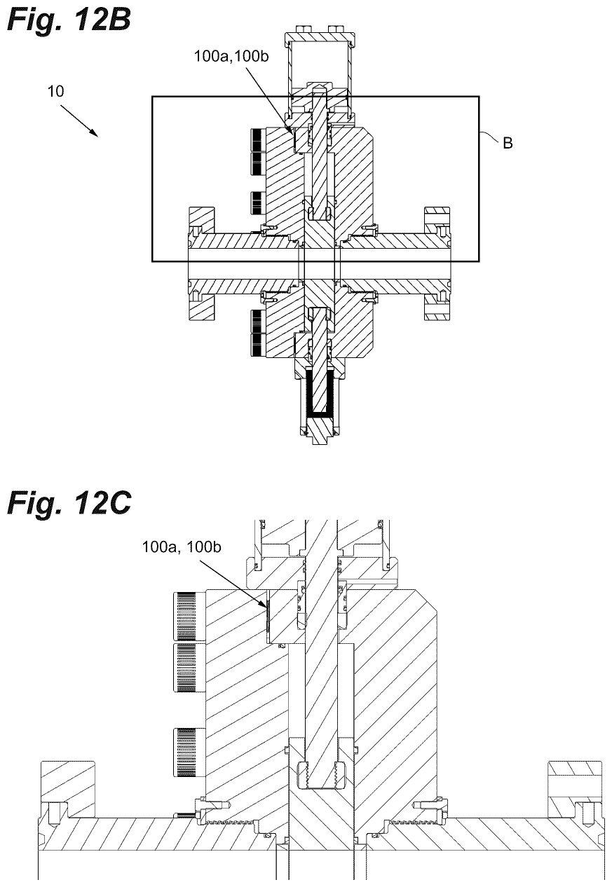

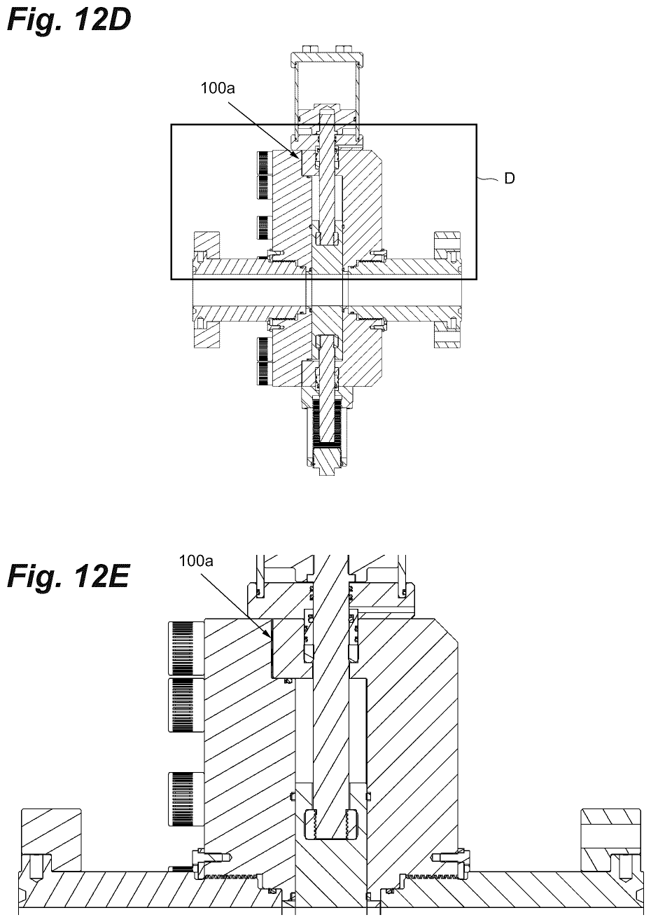

In a preferred embodiment shown in FIGS. 12A-12E, gate valve 10 further comprises a plurality of shims 100 positionable between the first and second mating faces 12f, 14f of the valve main body 12 and valve end cap 14. Shims 100 may be of similar metal material as the metal gasket (not shown) between the first and second mating faces 12f, 14f and function to allow an operator or owner of the gate valve 10 to control any gap between first seal 40a and the first gate cavity face 14gf of valve end cap 14 very precisely; i.e. the cap 14 can be shimmed to adjust tolerances and “squish” on the first seal 40a (and by force passing through the gate 30, also on the second seal 40b) when cap 14 is mated to body 12 via bolts 19. Shims may be provided as a paired set 100, 100′ (see FIG. 12A). FIGS. 12B-12C illustrated two sets of shims 100a, 100b, providing for less of a “squish” on seals 40a, 40b as compared to that shown in FIGS. 12D-12E, where there is only a single set of shims 100a.

The gate 30 comprises a gate bore or gate opening 300 offset substantially disposed in an end of the gate 30. A gate bore diameter 30d is preselected such that the gate bore 300 will not impede the free flow of fluid in the gate valve 10 when the gate 30 is in the open configuration, wherein the gate bore 300 is substantially in alignment with the flow passage 20. Typically, the gate bore diameter 30d is designed to be substantially the same as the flow passage diameter 20d. The gate valve 10 can also be positioned to a closed configuration when the gate bore 300 is moved into a position relative to the flow passage 20 such that the flow of fluid through the gate valve 100 is substantially reduced or eliminated. This closed configuration is accomplished by causing the gate 30 to move an appropriate amount within the gate cavity 12gc in a direction perpendicular (or substantially perpendicular) to direction of the flow passage 20 so that when the gate 30 is in contact with the first and second seals 40a, 40b, it intersects the flow passage 20 and substantially reduces or eliminates the flow of fluid between the first and second flanges 15a, 15b.

The straight legs 45a, 45b of the second profile of the seals 40, 40a, 40b are of such dimensions and length to ensure that the gate bore 300 is kept within the interior of the second profile 42 regardless of what configuration or position the gate 30 may be in during operation of the gate valve 10; i.e. even when the gate 30 is in the closed configuration, and the gate bore 300 is moved into a position relative to the flow passage 20 such that the flow of fluid through the gate valve 100 is substantially reduced or eliminated, the gate bore 300 is still within the inside or interior of the second profile 42 of the first and second seals 40a, 40b; see FIG. 3A. Preferably, and as shown in FIG. 5D, the outside diameter of the gate opening 300 is smaller than the distance D between the two straight legs 45a, 45b. More preferably, as the gate opening 300 reciprocates between the open and closed configurations, it is maintained within the spacing or distance D′ between the first and second semicircular members 44a, 44b (see FIG. 5E, illustrating the gate opening 300 as at the transition configuration).

Advantageously, second profile 42 prevents solids and debris from moving past the gate 30 and collect above the gate 30 and around the stem 30s. Any solids that may be within the fluid passing through the gate 10 will remain trapped within the gate's bore or opening 300, regardless of position of the gate 30 within the gate chamber 12gc; such solids then simply being flushed out of the gate opening 300 the next time the gate is in the open configuration. Even more advantageously, there is no longer any need (or a significantly reduced need) to flush out the stem chamber 30sc, and the gate valve 10 of the present invention can be oriented so that the flow passage 20 is vertical.

Referring to FIG. 9C, valve end cap 14 preferably comprises a first gate cavity face 14gf oriented along a plane 10p that is substantially parallel to the gate cavity center-line 10c and perpendicular to the bore center-line 20c. When the body 12 and cap 14 are assembled or mated together, the first gate cavity face 14gf then preferably forms a first side 13a of the gate cavity 12gc positioned radially outward from the gate cavity center-line 10c towards the first end 11a and adjacent the first flange 15a; see FIG. 9C.

More preferably, valve main body 12 further comprises a second gate cavity face 12gf oriented along a plane 10p that is also substantially parallel to the gate cavity center-line 10c and perpendicular to the bore center-line 20c. The second gate cavity face 12gf then preferably forms a second side 13b of the gate cavity 12gc positioned radially outward from the gate cavity center-line 10c towards the second end 11b and adjacent the second flange 15b; see FIG. 9C. The valve end cap 14 may further comprise a cap ledge 141 that projects from the first mating face 14f towards the second gate cavity face 12gf, and is of such dimensions and tolerances to removably, sealably fit within the valve main body 12 to provide a pressure fit between the body 12 and cap 12; as more clearly shown in the figures. Conventional seals S are preferably provided on either or both of the body 14 and cap 12 to ensure that, once mated, the body 12 and cap 14 can maintain a sufficient pressure seal and pressure rating within the gate cavity 12gc. For example, a seal groove 14g may be provided on the periphery of the cap ledge 141 to hold a seat or seal S; see FIG. 9C, which then seals against the interior surface of the gate cavity 12gc.

The valve main body 12 further comprises a body seal groove or pocket 50 on the second gate cavity face 12gf. Body seal groove 50 has a shape or profile that is a first profile 51 combined or overlapped with a second profile 52, and of such dimensions to accept a seal 40 disposed therewithin (e.g. a second seal 40b). Preferably, the first profile 51 is a circular profile (when viewed from the front or rear) comprised only of two semicircular grooves, namely an inner semicircular groove 53a and an outer semicircular groove 53b and is symmetric about the bore center-line 20c.

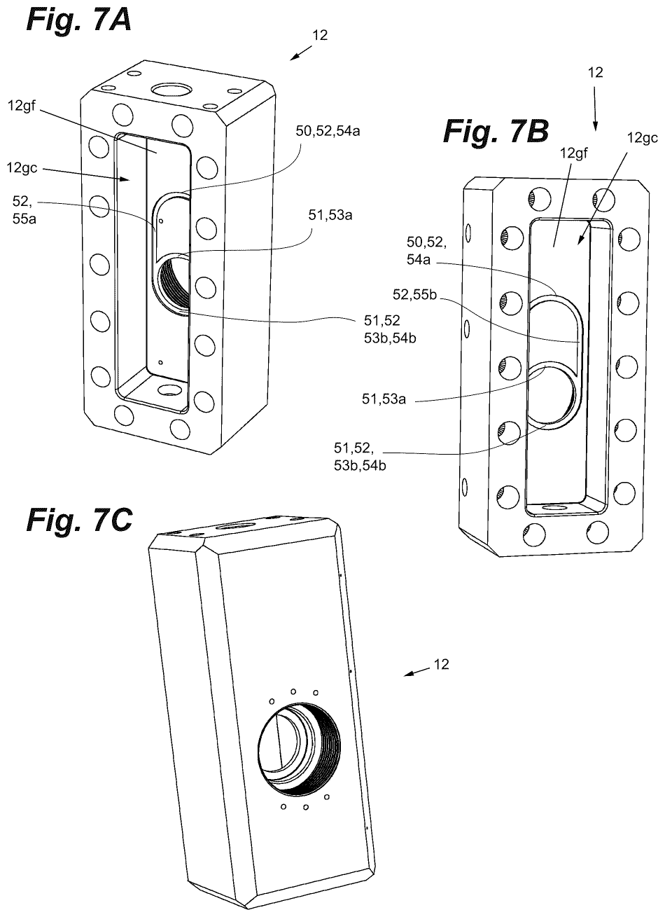

The second profile 52 is a stadium profile (when viewed from the front or rear). The second, stadium profile 52 of the seal pocket 50 comprises a geometric shape constructed of two semicircular grooves, namely a first semicircular groove 54a and a second semicircular grooves 54b positioned at opposite ends with a pair of straight grooves 55a, 55b therebetween. The two profiles 51, 52 are combined by virtue of the fact that the outermost semicircular groove 53b is the same groove as the second semicircular groove 54b; see FIGS. 7A-7B.

The valve end cap 14 further comprises a cap seal groove or pocket 60 on the first gate cavity face 14gf. Cap seal groove 60 has shape or profile that is a first profile 61 combined or overlapped with a second profile 62, and of such dimensions to accept a seal 40 disposed therewithin (e.g. a second seal 40a). Preferably, the first profile 61 is a circular profile (when viewed from the front or rear) comprised only of two semicircular grooves, namely an inner semicircular groove 63a and an outer semicircular groove 63b and is symmetric about the bore center-line 20c.

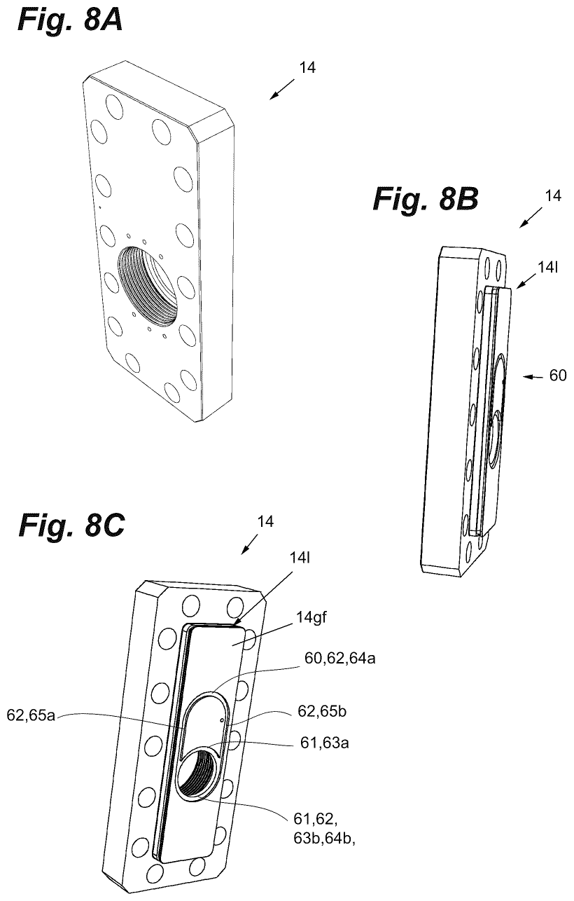

The second profile 62 is a stadium profile (when viewed from the front or rear). The second, stadium profile 62 of the seal pocket 60 comprises a geometric shape constructed of two semicircular grooves, namely a first semicircular groove 64a and a second semicircular groove 64b positioned at opposite ends with a pair of straight grooves 65a, 65b therebetween. The two profiles 61, 62 are combined by virtue of the fact that the outermost semicircular groove 63b is the same groove as the second semicircular groove 64b; see FIG. 8C.

Advantageously, by having valve main body 12 and valve end cap 14 removably, sealably mate or assemble together to form the gate cavity 12gc, and by having the first and second gate cavity faces (14gf, 12gf) oriented substantially along plane 10p, the body seal groove 50 can be easily machined or milled out of the second gate cavity face 12gf during manufacturing, and the cap seal groove 60 can likewise be easily machined or milled out of the first gate cavity face 14gf during manufacturing.

Preferably, the first profile 41 of the first seal 40a further has an inner diameter 41i such that the opening 410 in the seal 40a is substantially commensurate with the flow passage 20 and the gate opening 300. A seal thickness is chosen so that the gate 30 engages with the seal 40a rather than the first gate cavity face 14gf but wherein the seal 40a is substantially disposed within the pocket 60. The dimensions and materials of the seal 40a are determined based on the working pressure and the contact or bearing stress. One of skill in the art will be able to readily adapt such dimensions and materials accordingly.

More preferably, the first profile 41 of the second seal 40b further has an inner diameter 41i such that the opening 410 in the seal 40b is substantially commensurate with the flow passage 20 and the gate opening 300. A seal thickness is chosen so that the gate 30 engages with the seal 40b rather than the second gate cavity face 12gf but wherein the seal 40a is substantially disposed within the pocket 50. The dimensions and materials of the seal 40b are determined based on the working pressure and the contact or bearing stress. One of skill in the art will be able to readily adapt such dimensions and materials accordingly.

### ADDITIONAL EMBODIMENTS

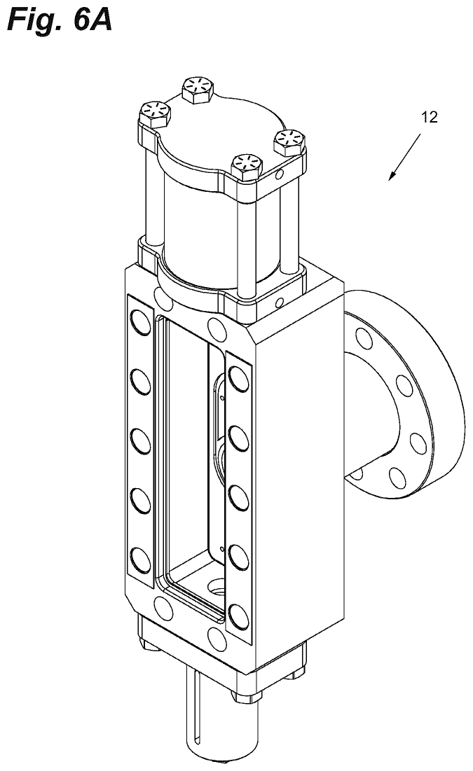

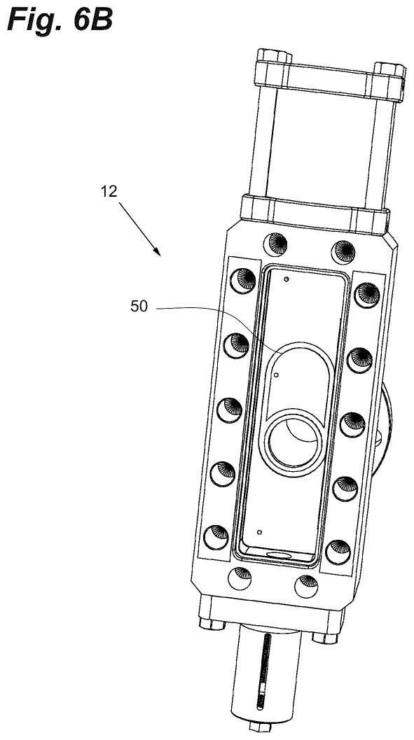

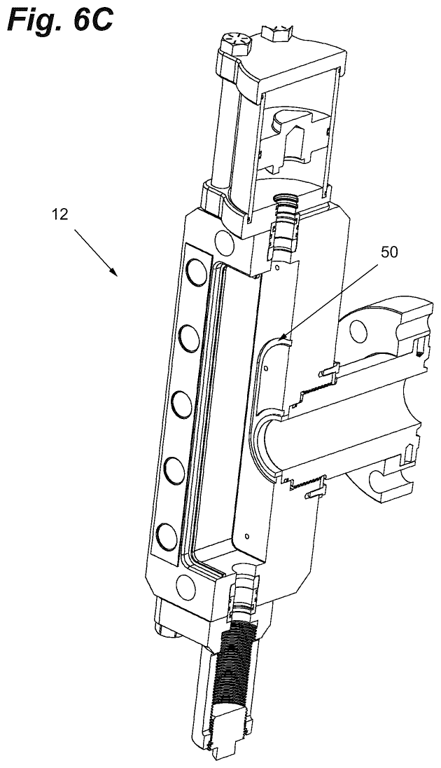

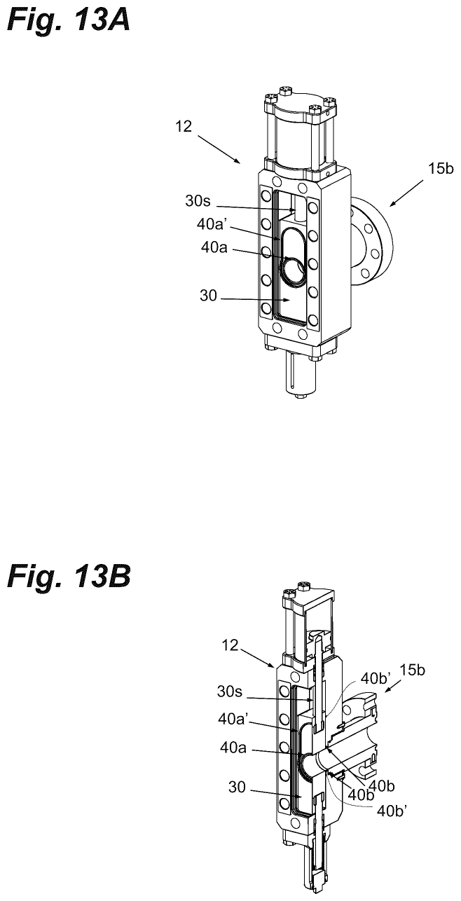

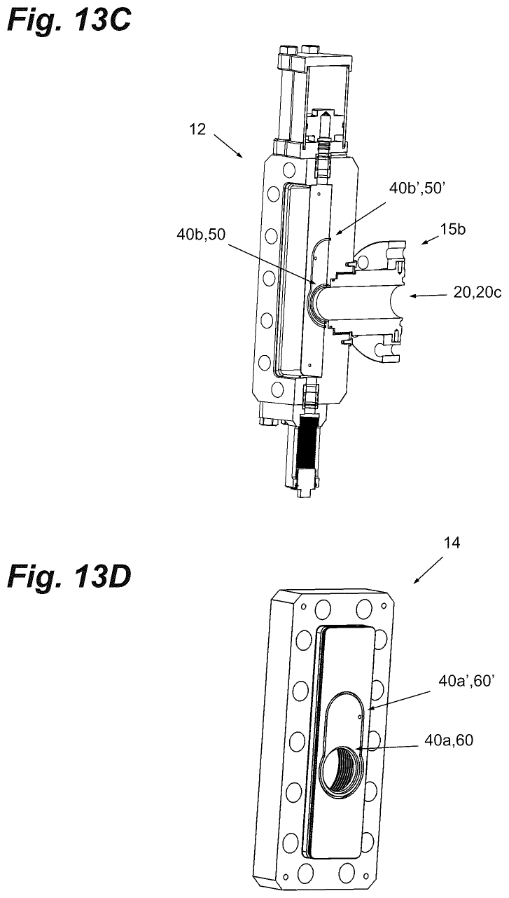

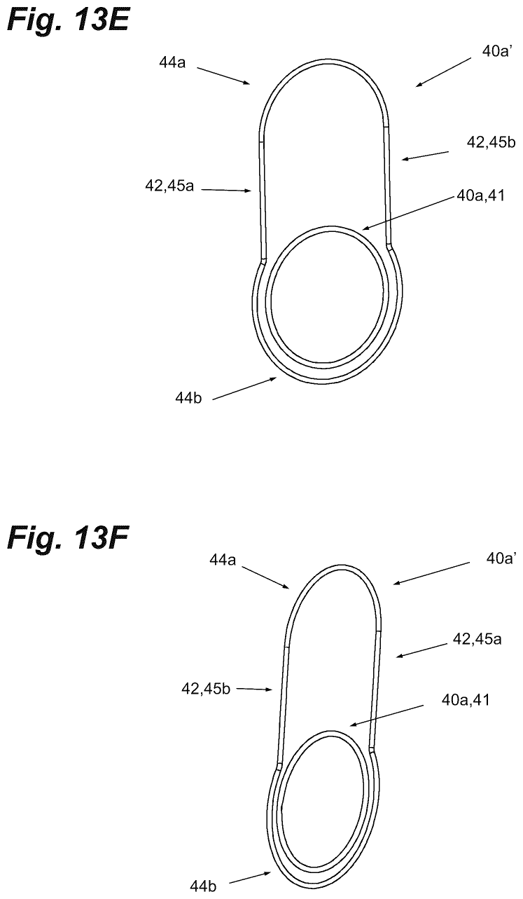

In another embodiment of the gate valve 10, and referring to FIGS. 13A-13F, the gate valve 10 is similar to the embodiment of FIGS. 2A-12E except that the pair of gate seals 40, i.e. the first seal 40a and the second seal 40b, and the corresponding seal grooves 50, 60 are replaced with two pairs of gate seals 40a, 40a′, 40b, 40b′ and two pairs of seal grooves 50, 50′, 60, 60′. This embodiment comprises a first pair of seals 40a, 40a′ and a second pair of seals 40b, 40b′, wherein the two seal profiles 41, 42 of the embodiment of FIGS. 2A-12E) are each embodied in a separate set of seals—i.e. the first profile 41 is embodied in the first set of seals 40a, 40b, while the second profile 42 is embodied in second set of seals 40a′, 40b′—as illustrated in FIGS. 13A-13F.

In a preferred embodiment, the first set of seals 40a, 40b are made of an alloy steel or a coated steel, to reduce the chance that a portion of said seals 40a, 40b is pushed or deformed into gate bore or gate opening 300 when under pressure. More preferably, the second set of seals 40a′, 40b′ are made of an elastomer material or Teflon™ to provide better longevity characteristics, less friction, and less force required to engage it.

In this embodiment of the gate vale 10, and as shown in FIGS. 13A-13F, the first profile 41 embodied in the first set of seals 40a, 40b is a circular profile. Further in this embodiment, the second profile 42 embodied in the second set of seals 40a′, 40b′ is a modified stadium profile comprising a geometric shape constructed of two semicircular members, namely a first semicircular member 44a and a second semicircular member 44b positioned at opposite ends 40e, 40e′ with a pair of straight legs 45a, 45b therebetween, and wherein the end 40e′ comprising the second semicircular member 44b is of sufficient diameter so as to fully encircle or encompass the first profile 41 (as embodied in seals 40a, 40b).

The valve main body 12 further comprises a pair of body seal grooves or pockets 50,50′ on the second gate cavity face 12gf of suitable dimensions to accept seals 40b, 40b′ therein in a conventional manner; i.e. cap seal groove 50 has shape or profile that is a circular profile (to accept seal 40b) and cap seal groove 50′ has a modified stadium profile (to accept seal 40b′); see FIG. 13C.

The valve end cap 14 of this embodiment further comprises a pair of cap seal grooves or pockets 60, 60′ on the first gate cavity face of suitable dimensions to accept seals 40a, 40a′ therein in a conventional manner; i.e. cap seal groove 60 has a circular profile (to accept seal 40a′) and cap seal groove 60′ has a modified stadium profile (to accept seal 40a′); see FIG. 13D.

Similar to the embodiment of FIGS. 2A-12E, the circular profile 41 of the seals 40a, 40b each have an inner diameter such that the opening in these seals is substantially commensurate with the flow passage 20 and the gate opening 300. A seal thickness is chosen so that the gate 30 engages with the seals 40a, 40b rather than the first and second gate cavity faces but wherein the seals 40a, 40b are substantially disposed within their respective pockets 50, 60. The dimensions and materials of the seals 40a, 40b are determined based on the working pressure and the contact or bearing stress. One of skill in the art will be able to readily adapt such dimensions and materials accordingly.

Similar to the embodiment of FIGS. 2A-12E, the modified stadium profile 42 of the seals 40a′, 40b′ have such dimensions to ensure that, as the gate opening 300 reciprocates between the open and closed configurations, it is maintained within the seals 40a′, 40b′. The straight legs 45a, 45b of the modified stadium profile 42 of the seals 40a′, 40b′ are of such dimensions and length to ensure that the gate bore 300 is kept within the interior of that profile 42 regardless of what configuration or position the gate 30 may be in during operation of the gate valve 10; i.e. even when the gate 30 is in the closed configuration, and the gate bore 300 is moved into a position relative to the flow passage 20 such that the flow of fluid through the gate valve 10 is substantially reduced or eliminated, the gate bore 300 is still within the inside or interior of the second profile 42 of seals 40a′, 40b′.

Advantageously, and similar to the embodiment of FIGS. 2A-12E, the second profile 42 in this embodiment prevents solids and debris from moving past the gate 30 and collect above the gate 30 and around the stem 30s. Any solids that may be within the fluid passing through the gate 10 will remain trapped within the gate's bore or opening 300, regardless of position of the gate 30 within the gate chamber 12gc; such solids then simply being flushed out of the gate opening 300 the next time the gate is in the open configuration.

A seal thickness is chosen so that the gate 30 engages with the seals 40a′, 40b′ rather than the first and second gate cavity faces but wherein the seals 40a′, 40b′ are substantially disposed within their respective pockets 50′, 60′. The dimensions and materials of the seals 40a′, 40b′ are determined based on the working pressure and the contact or bearing stress. One of skill in the art will be able to readily adapt such dimensions and materials accordingly.

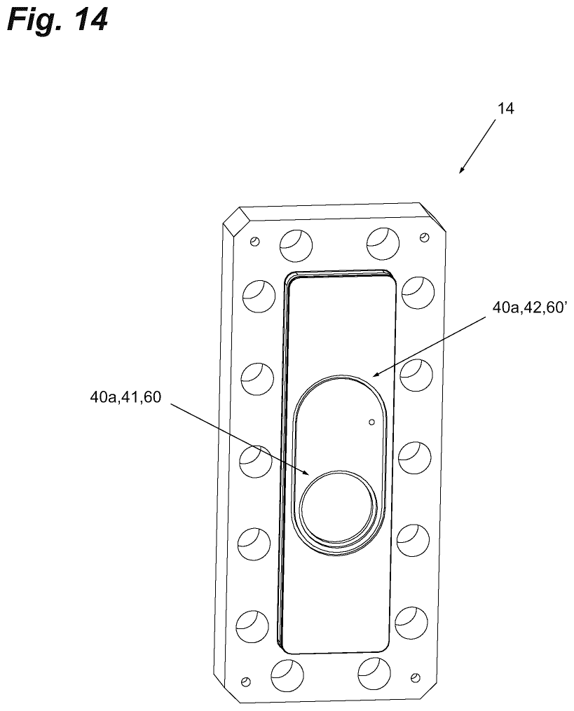

In another embodiment of the gate valve 10, and as shown in FIG. 14, the gate valve 10 is similar to the embodiment of FIGS. 13A-13F except that the second profile 42 of the seals 40a′, 40b′ is a stadium profile (not a modified stadium profile). Like the embodiment of FIGS. 13A-13F, the second profile 42 in this embodiment is of such dimensions to ensure that, as the gate opening 300 reciprocates between the open and closed configurations, it is maintained within the seals 40a′, 40b′. Advantageous, the second profile 42 in this embodiment prevents solids and debris from moving past the gate 30 and collect above the gate 30 and around the stem 30s. Any solids that may be within the fluid passing through the gate 10 will remain trapped within the gate's bore or opening 300, regardless of position of the gate 30 within the gate chamber 12gc; such solids then simply being flushed out of the gate opening 300 the next time the gate is in the open configuration.

As will now be understood by those of skill in the art, the first (circular) profile of the seals, as embodied in the first and second seals 40a, 40b of the embodiment of FIGS. 2A-12E, or as embodied in the first set of seals 40a, 40b of the embodiments of FIGS. 13A-14, provide the sealing functionality of the gate valve 10 when in the closed configuration so that the flow through the gate is substantially blocked such that fluid does not pass from one side (11a) of the gate valve to the other side (11b). As will now also be understood by those of skill in the art, the second (stadium or modified stadium) profile 42 of the seals, as embodied in the first and second seals 40a, 40b of the embodiment of FIGS. 2A-12E, or as embodied in the second set of seals 40a′, 40b′ of the embodiments of FIGS. 13A-14, prevents solids and debris from moving past the gate 30 and collect above the gate 30 and around the stem 30s—i.e. the second profile 42 seals the gate opening 300 from (or relative to) the gate stem 30s. Any solids that may be within the fluid passing through the gate 10 will remain trapped within the gate's bore or opening 300, regardless of position of the gate 30 within the gate chamber 12gc; such solids then simply being flushed out of the gate opening 300 the next time the gate is in the open configuration.

Those of ordinary skill in the art will appreciate that various modifications to the invention as described herein will be possible without falling outside the scope of the invention. In the claims, the word “comprising” is used in its inclusive sense and does not exclude other elements being present. The indefinite article “a” before a claim feature does not exclude more than one of the features being present.

1. A gate valve (10) comprising:
a first end (11a) and a second end (11b);
a gate (30) having a gate opening (300), the gate (30) positionable within the valve (10) between a closed configuration, a transition configuration and an open configuration;
a gate stem (30s);
at least one pair of seals (40a, 40b) comprising a first seal (40a) and a second seal (40b) wherein one of each seal (40a, 40b) is positioned on either side of the gate (30);
wherein each of said seals (40a, 40b) comprises a first profile (41) and a second profile (42);
wherein said first profile (41) seals the gate valve (10) and blocks fluid from passing between the first end (11a) and the second end (11b) when the gate valve (10) is in the closed configuration; and
wherein the second profile (42) seals the gate opening (300) relative to the gate stem (30s).

2. The gate valve (10) of claim 2 further comprising:
a valve main body (12);
a valve end cap (14)
